(19) United States
(12) Patent Application Publication
(10) Pub. No.: US 2011/0195648 A1
(43) Pub. Date: Aug. 11, 2011

(54) COLLAPSIBLE FILLET BOARD

(76) Inventor: Errik Ovard, Kamas, UT (US)

(21) Appl. No.: 12/702,120

(22) Filed: Feb. 8, 2010

(51) Int. Cl. A22C 25/06

(52) U.S. Cl. 452/194

(57) ABSTRACT

A fish fillet board is adapted to stand upright during use, and to collapse into a folded position during storage. The fillet board comprises two planar surface members, hingedly connected at their upper surface, with smooth outer surfaces for fillet, cleaning and cutting fish. The two planar surface members comprise rough inner surfaces for preventing slippage while gutting fish preparatory to subsequent filleting. The surface members may double as housings for cutting instruments. A plurality of stabilizing spikes arrayed across the medial axis of the fillet board pierce the fish and help prevent slippage during filleting in the upright position.

### FIELD OF THE INVENTION

This invention relates to outdoor equipment and cutting instruments, and more particularly relates to a device for gutting and filleting fish.

### BACKGROUND

### Description of the Related Art

Fishermen across the world find it difficult to gut and fillet newly caught fish in the outdoors. Traditional fillet boards teach only the use of a single planar surface to expose only one side of the fish to the fisherman at a time. Fillet boards that are not flat are cumbersome for fisherman to store and transport in the outdoors. Even those fillet boards which comprise clamps for securing the fish during filleting only secure the head or tail of the fish rather than the body of the fish being filleted.

Fisherman often find it difficult to prevent the fish from slipping to-and-fro on wet fillet boards and to prevent the fillet board itself from slipping across wet surfaces used to support the fillet board. Often, fishermen must use one hand to secure the fish and the fillet board while trying to fillet the fish with the other hand.

Fishermen further find it difficult to store the cutting instruments needed to fillet the fish in close proximity to the fillet board. On some occasions, fisherman find they have lost possession of one or more of the instruments and devices needed for filleting the fish when preparing to do so.

### SUMMARY

From the foregoing discussion, it should be apparent that a need exists for an apparatus to facilitate more convenient filleting of fish. Beneficially, such an apparatus would expose both sides of the fish to a fisherman simultaneously, prevent slippage of the fish and fillet board to make both hands available to the fisherman, store cutting instruments, and be easily transportable.

The present invention has been developed in response to the present state of the art, and in particular, in response to the problems and needs in the art that have not yet been fully solved by currently available fillet boards. Accordingly, the present invention has been developed to provide a fillet board that overcomes many or all of the above-discussed shortcomings in the art.

A fillet board is provided comprising an oblong left sidewall comprising a planar outer surface and an inner surface and an oblong right sidewall, hingedly connected at its upper surface to the upper surface of the left sidewall, comprising a planar outer surface and an inner surface.

The fillet board is some embodiments, further comprises one or more medial axis hinges, connecting the left sidewall and the right sidewall, configured to lock when opened to a predetermined distance. The left sidewall and the right sidewall may encapsulate one more cutting instruments.

The inner surfaces of the left sidewall and the inner surface of the right sidewall may be textured to prevent slippage of a fish resting between the left sidewall and the right sidewall.

The fillet board may further comprise a plurality of spiked protrusions mounted to one or more of the upper surface of the left sidewall and the upper surface of the right sidewall.

The fillet board may further comprise a plurality of rubber grommets mounted to the lower surface of the left sidewall and the lower surface of the right sidewall to create friction between the fillet board and a subsurface upon which the fillet board is resting in the upright position.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is top perspective view of a collapsible fillet board in the upright position accordance with the present invention;

FIG. 2 is top perspective view of a collapsible fillet board in the collapsed position accordance with the present invention;

FIG. 3 is a side perspective view of another embodiment of a collapsible fillet board in accordance with the present invention;

FIG. 4 is a top perspective view of another embodiment of a fillet board in accordance with the present invention;

FIG. 5 is lower perspective view of a fillet board in accordance with the present invention;

FIG. 6 is side perspective view of a fillet board in accordance with the present invention; and

FIG. 7 is side perspective view of a fillet board in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps between enumerated steps of the depicted method. Additionally, the order in which a particular method occurs may or may not strictly adhere to the order of the corresponding steps shown.

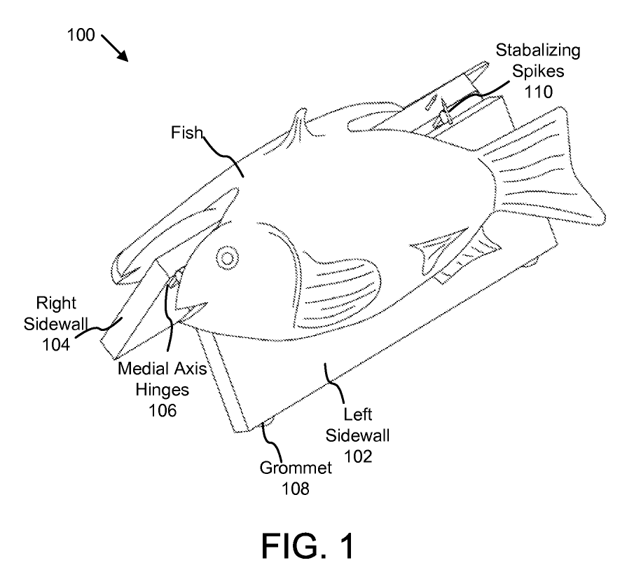

FIG. 1 is top perspective view of a collapsible fillet board 100 in the upright position accordance with the present invention. FIG. 1 includes a left sidewall 102, a right sidewall 104, medial axis hinges 106, a grommet 108, and stabilizing spikes 110.

The left sidewall 102 comprises, in the shown embodiment, a generally rectangular planar surface member that may vary in size and dimensions from only two inches long to more than twenty feet long, and from only two inches high to more than twenty feet high.

In the shown embodiment, the left sidewall 102 is made of wood, but may be also comprise any rigid substance, including polymers, metals, stone and the like.

In some embodiments, the left sidewall 102 comprises an irregularly shaped upper surface contoured to match the off-linear path of a fish's spine or innards.

The right sidewall 104 is substantially similar in shape and make to the left sidewall 102, but forms the left side of the collapsible fillet board 100. The right sidewall 104, in the shown embodiment, is hingedly attached to the left sidewall 102. In other embodiments, the right sidewall 104 is rigidly attached to the left sidewall 102 such that the fillet board 100 remains constantly in an upright position.

Because the right sidewall 104 is hingedly attached, in the shown embodiment, to the left sidewall 102, the fillet board 100 is collapsible. The right sidewall 104 may be folded by a human operator against the left sidewall 102 for storage or transport.

The left sidewall 104 is hingedly connected to the right sidewall 102 using medial axis hinges 106. Medial axis hinges 106 may comprise any hinge well-known to those of skill in the art. These medial axis hinges 106 are configured to open only to a predetermined degree, such that when they are open, the left sidewall 102 and the right sidewall 104 are separated by a distance calculated to provide stability to the fillet board 100 when resting on when resting on the lower edges of the left sidewall 102 and the right sidewall 104. In this manner, the fillet board 100 provides a stable, upright tool which fisherman can use to fillet both sides of a fish laid on top of the fillet board 100 as shown in this embodiment.

The grommet 108 comprises a rubber stopper affixed to the lower edges of the right sidewall 104 and the left sidewall 102. A fisherman making use of a fillet board 100 with one or more grommets 108 affixed to it can prevent the fillet board 100 from scratching surfaces or subgrades upon which it is places or used. The grommet 108 also serves to increase friction between the fillet board 100 and the surface upon it rests while in the upright position to reduce the tendency of the fillet board to slide across the surface during use.

The stabilizing spikes 110 comprise, in the shown embodiment, sharp conical-shaped protrusions jetting from the upper surface of the left sidewall 102 and/or the right sidewall 104.

The stabilizing spikes 110 pierce the back of a fish placed on top of the fillet board 100 and stabilize the body of the fish during filleting. The stabilizing spikes 110 may vary in length from less than a millimeter to more than a meter. The stabilizing spikes 110 may be nail-like in shape, and made from any rigid material capable of maintaining a point, including metal, stone and/or plastics.

In some embodiments of the present invention, the outer surface of the left sidewall 102 and the right sidewall 104 are textured to prevent a fish resting on the fillet board 100 from slipping. In some embodiments, the outer walls of the left sidewall 102 and the right sidewall 104 comprise a sandpaper-like texture meant to increase the friction between the fish and the fillet board 100.

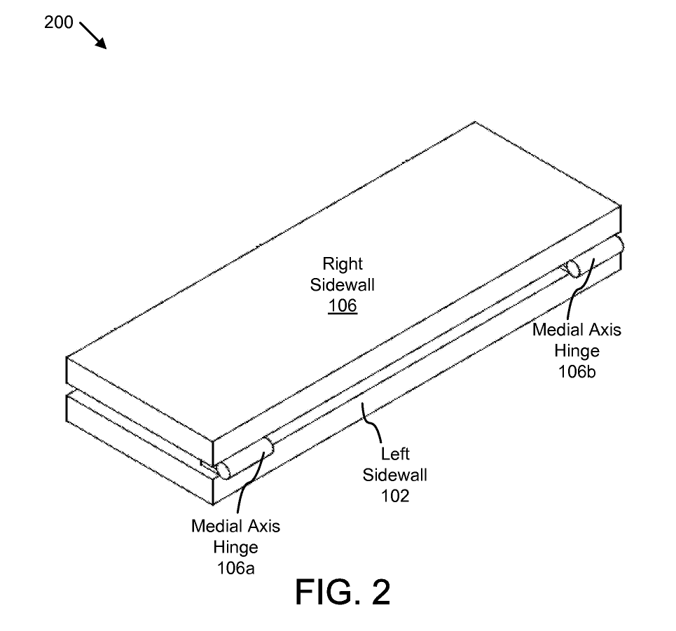

FIG. 2 is top perspective view of a collapsible fillet board 200 in the collapsed position accordance with the present invention. FIG. 2 includes a left sidewall 102, a right sidewall 104, and medial axis hinges 106.

The fillet board 200 is shown in the collapsed, or folded position.

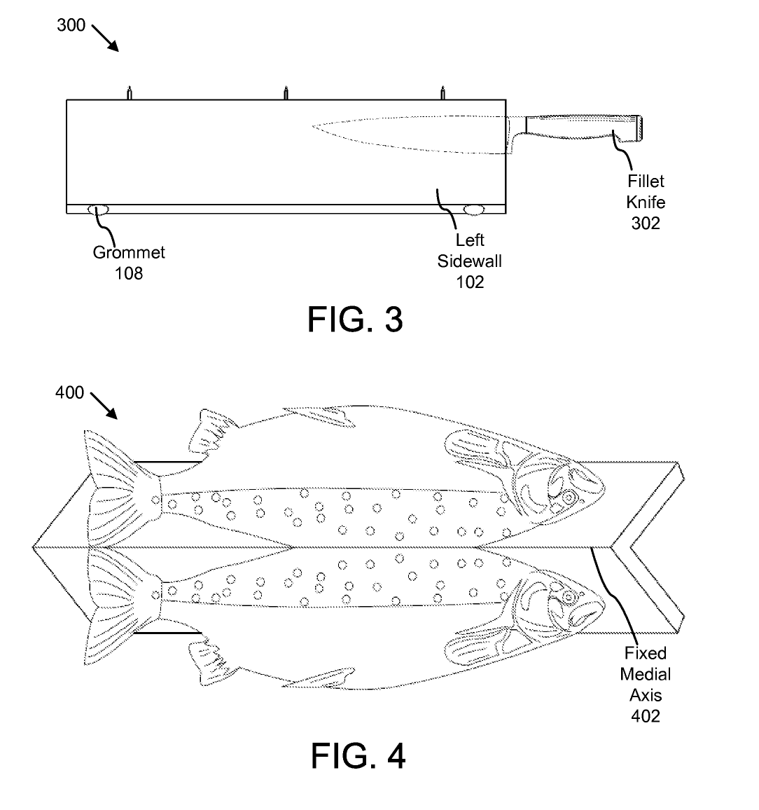

FIG. 3 is a side perspective view of another embodiment of a collapsible fillet board 300 in accordance with the present invention.

The fillet board 300 in the shown embodiment comprises cavities encapsulated within the right sidewall 104 and/or the left sidewall 102. These cavities may wholly or partially encapsulate cutting instruments like a fillet knife 302 required to fillet fish using the fillet board 300.

In some embodiments, these capsules hold cutting instruments, like fillet knifes 302, safely in place until the knife is released using means well-known to those of skill in the art.

FIG. 4 is a top perspective view of another embodiment of a fillet board 400 in accordance with the present invention.

In the shown embodiment, the left sidewall 102 and the right sidewall 104 are rigidly coupled together at the upper surfaces.

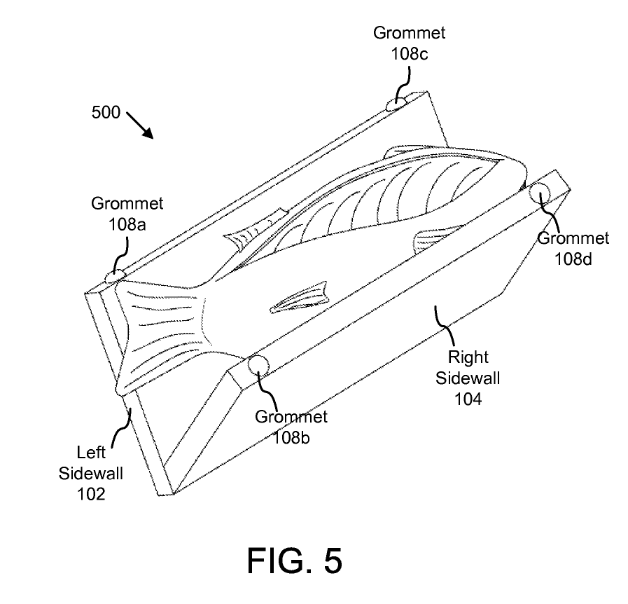

FIG. 5 is lower perspective view of a fillet board 500 in accordance with the present invention. FIG. 5 includes a left sidewall 102, and grommets 108a-d.

When the fillet board 500 is open, or in its non-collapsed position, the fillet board 500 may be inverted and used to gut fish rather than fillet them. A fisherman rests a fish inside the inverted fillet board 500 as shown in this embodiment. The fisherman may clamp down on the fish by pressing the left sidewall 102 and the right sidewall 104 together to prevent the fish from slipping.

In some embodiments of the present invention, the inner surfaces of the left sidewall 102 and the right sidewall 104 are textured to prevent a fish resting inside the fillet board 500 while inverted from slipping. In some embodiments, the inner walls of the left sidewall 102 and the right sidewall 104 comprise a sandpaper-like texture meant to increase the friction between the fish's skin and the fillet board 500.

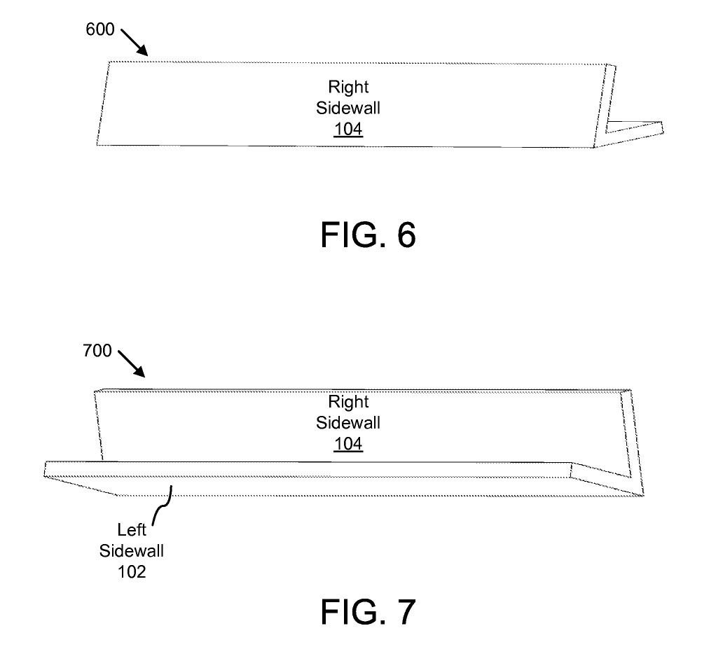

FIG. 6 is side perspective view of a fillet board in accordance with the present invention.

FIG. 7 is side perspective view of a fillet board in accordance with the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A collapsible fillet board comprising:
an oblong left sidewall comprising a planar outer surface and an inner surface; and
an oblong right sidewall, hingedly connected at its upper surface to the upper surface of the left sidewall, comprising a planar outer surface and an inner surface.

2. The fillet board of claim 1, further comprising one or more medial axis hinges, connecting the left sidewall and the right sidewall, configured to lock when opened to a predetermined distance.

3. The fillet board of claim 1, in which one or more of the left sidewall and the right sidewall encapsulate one more cutting instruments.

4. The fillet board of claim 1, in which the inner surfaces of the left sidewall and the inner surface of the right sidewall are textured to prevent slippage of a fish resting between the left sidewall and the right sidewall.

5. The fillet board of claim 1, further comprising a plurality of spiked protrusions mounted to one or more of the upper surface of the left sidewall and the upper surface of the right sidewall.

6. The fillet board of claim 1, further comprising a plurality of rubber grommets mounted to the lower surface of the left sidewall and the lower surface of the right sidewall to create friction between the fillet board and a subsurface upon which the fillet board is resting in the upright position.

7. The fillet board of claim 1, in which the left sidewall and the right sidewall comprise grates through which innards and bodily fluids of the fish can drain during filleting.

8. The fillet board of claim 1, further comprising a hook coupled to a surface of the collapsible fillet board for suspending the collapsible fillet board on a wall.

9. A fillet board comprising:
an oblong left sidewall comprising a textured planar outer surface and a textured planar inner surface;
an oblong right sidewall rigidly connected at its upper surface to the upper surface of the left sidewall, comprising a textured planar outer surface and a textured planar inner surface; and
a plurality of spiked protrusions mounted to one or more of the upper surface of the left sidewall and the upper surface of the right sidewall.
